(19) United States
(12) Patent Application Publication
(10) Pub. No.: US 2016/0011733 A1
(43) Pub. Date: Jan. 14, 2016

(54) GUIDED EXPLORATION OF AN EXHIBITION ENVIRONMENT

(71) Applicant: CLEVELAND MUSEUM OF ART, Cleveland, OH (US)

(72) Inventors: C. GRIFFITH MANN, CLEVELAND, OH (US); CAROLINE GOESER, CLEVELAND, OH (US); JANE ALEXANDER, CLEVELAND, OH (US); JEFFREY STREAN, CLEVELAND, OH (US)

(21) Appl. No.: 14/777,175

(22) PCT Filed: Mar. 6, 2014
(86) PCT No.: PCT/US14/20967

§ 371 Date: Sep. 15, 2015

Related U.S. Application Data
(60) Provisional application No. 61/787,525, filed on Mar. 15, 2013.

(51) Int. Cl. G06F 3/0484; G09B 11/10; G09B 5/02; G09B 19/00

(52) U.S. Cl. CPC G06F 3/0484; G09B 19/0023; G09B 11/10; G09B 5/02

(57) ABSTRACT

Systems and methods to create an interactive experience for visitors of an exhibition environment. The system harmonizes interpretation, learning, and personalization through the use of interactive media to enhance the visitor experience in the exhibition environment and, thereby, enrich the visitors to a greater extent. Interactive systems are employed to cultivate, in the visitor, knowledge on interpretative concepts, which can be leveraged throughout the exhibition environment. Visitors learn tools to facilitate engagement with works in the exhibition environment and to better explore personal interests. These tools, learned through the interactive systems, empower visitors to explore the exhibition environment, to attach personal meaning to the works in the exhibition environment, and to increase an overall appreciation of the works in the exhibition environment.

### CROSS-REFERENCE TO RELATED APPLICATIONS

This application claims priority to U.S. Provisional Application Ser. No. 61/787,525, filed Mar. 15, 2013, entitled “SYSTEMS AND METHODS FOR VIRTUAL TOUR CREATION BASED ON USER INPUT”, the entirety of which is incorporated herein by reference.

### BACKGROUND OF THE INVENTION

1. Field of the Invention

This application relates generally to an exploration system for an exhibition environment and, more specifically, to a method of guiding exploration of an exhibition environment and systems for teaching interpretative and evaluative techniques to empower exploration of an exhibition environment.

2. Description of Related Art

Exhibition environments, such as museums (art, natural history, etc.), display large collections of exhibits and works for the enjoyment of visitors. These collections are typically organized into specific exhibitions or groups by skilled curators. Such organization can be based on specific criteria selected by the curators such that works sharing a particular theme, time period, artist, medium, creation technique, etc. are grouped together.

In such typical exhibition environments, visitors can proceed on tours. However, such tours are commonly limited to following a path laid out according to the specific criteria selected by the curators or to exploring the venue with no pre-determined path or plan. While it is true that a visitor can embark on a self-guided tour through the exhibition environment, the visitor quite often lacks prior knowledge of the works and exhibitions on display, and/or the locations of the works and exhibitions within the environment. Accordingly, such self-guided tours are often indistinguishable from aimless wandering.

Moreover, within the exhibition environments, the exhibitions and works are conventionally displayed adjacent to informative plaques or museum labels. These labels provide basic information. For example, in an art museum, the labels can include artist names, dates of creation, titles, and interesting trivia facts.

Thus, while exhibition environments, such as art museums, provide outstanding access to beautiful exhibitions and works, conventional environments fail to provide additional tools to enable a visitor to interpret the exhibitions and works. Accordingly, visitors, and particularly laypersons, are not offered an engaging experience with which to fully appreciate the works.

### BRIEF SUMMARY OF THE INVENTION

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

In various, non-limiting embodiments, an engagement system provides a rich, interactive experience to visitors of an exhibition environment. The engagement system facilitates education of visitors on various concepts, topics, techniques, etc., which are employable to engage and explore works within the exhibition environment. The engagement system further facilitates propelling visitors, thus educated, into an entirety of the exhibition environment. Such visitors, empowered with specific knowledge, develop greater engagement with the works of the environment, attach personal meaning to the works, create personalized experiences, and generally promote a greater appreciation of the works of the exhibition environment and the exhibition environment itself (i.e., the goals and purpose of the environment).

These and other embodiments are described in more detail below.

### BRIEF DESCRIPTION OF THE DRAWING

Various non-limiting embodiments are further described with reference the accompanying drawings in which:

FIG. 1 is a block diagram of an exemplary, non-limiting engagement system according to one or more aspects;

FIG. 2 is a block diagram of an exemplary, non-limiting education subsystem including one or more interactive apparatuses;

FIG. 3 is a block diagram of an exemplary, non-limiting exploration subsystem according to one or more aspects;

FIG. 4 is a schematic diagram of an exemplary, non-limiting hub apparatus;

FIG. 5 is a block diagram of an exemplary, non-limiting launch apparatus;

FIG. 6 is a schematic diagram of an exemplary, non-limiting collection wall apparatus according to one or more aspects;

FIG. 7 is a schematic diagram of an exemplary, non-limiting exhibition environment in accordance with one or more aspects;

FIG. 8 is a block diagram of an exemplary, non-limiting engagement system implemented in an exhibition environment;

FIG. 9 is a block diagram of an exemplary, non-limiting interactive system according to one or more aspects;

FIG. 10 is a schematic diagram of an exemplary, non-limiting portable device in accordance with an aspect;

FIG. 11 is a block diagram of an exemplary, non-limiting embodiment for a collection wall according to one or more aspects;

FIG. 12 is a block diagram representing an exemplary, non-limiting networked environments in which various embodiments described herein can be implemented; and

FIG. 13 is a block diagram representing an exemplary, non-limiting computing system or operating environment in which one or more aspects of various embodiments described herein can be implemented.

### DETAILED DESCRIPTION OF THE INVENTION

### General Overview

As discussed in the background, conventional exhibition environments, such as museums, typically offer a static experience where works are displayed to visitors and/or information is presented, unilaterally, to the visitors. In other words, conventional exhibition environments do not provide an experience that actively engages visitors with the works and exhibits. Rather, through the use of conventional museum labels, visitors are provided a passive experience.

In various, non-limiting embodiments, a system is provided to create an interactive experience for visitors of an exhibition environment. The system harmonizes interpretation, learning, and personalization through the use of interactive media to enhance the visitor experience in the exhibition environment and, thereby, enrich the visitors to a greater extent. For instance, interactive systems are employed to cultivate, in the visitor, knowledge on interpretative concepts, which can be leveraged throughout the exhibition environment. Visitors learn tools to facilitate engagement with works in the exhibition environment and to better explore personal interests. These tools, learned through the interactive systems, empower visitors to explore the exhibition environment, to attach personal meaning to the works in the exhibition environment, and to increase an overall appreciation of the works in the exhibition environment.

As used herein, an “exhibition environment” or “environment” can refer to a physical or virtual location in which works or exhibits are presented. The term “work”, as utilized herein, can be a physical or virtual object accessible in the environment. For example, the exhibition environment can be an art museum or gallery and the work can be a piece of art (e.g., a painting, sculpture, photograph, drawing, etc.). However, it is to be appreciated that other exhibition environments beyond art museums are contemplated to employ the systems and methods described herein. For instance exhibition environments such as natural history museums, industry museums (e.g., technology museums, mining museums, manufacturing museums, etc.), sports museums (i.e., Halls of Fame), or museums on specific topics or concepts (e.g., museum of computer science, museum of inventions, software or video game museum, etc.). Accordingly, a work on display in an exhibition environment can be varied and include a portion of digital media (e.g., video, audio, etc.), or substantially any object suitable for display in the exhibition environment (e.g., archaeological artifacts, historical objects, antiques, etc.). It is to be further appreciated that an exhibition environment, as utilized and described herein, can extend to a commercial or retail establishment. For instance, the “works” can be goods or services offered by a store.

In one embodiment, a system for exploring an exhibition environment is described herein that includes a content management system. The content management system can include non-transitory computer-readable media having stored thereon digital representations of a plurality of works and annotative data respectively associated with the plurality of works. The system can also include an education subsystem communicatively coupled with the content management system. The education subsystem is configured to convey information related to at least one concept or technique employable by a visitor to evaluate works. The information is conveyed relative to a first set of works of the plurality of works. The system further includes an exploration subsystem, which is communicatively coupled with the content management system and the educational subsystem. The exploration subsystem is configured to guide the visitor to explore a second set of works of the plurality of works. The second set of works is selected based on at least one of input received from the visitor or characteristics associated with the first set of works to enable the visitor to engage with works of the second set of works in accordance with the at least one concept or technique conveyed by the educational subsystem.

According to an example, the education subsystem can include one or more computing devices having respective processors configured to execute computer-executable instructions and one or more multi-touch displays operatively coupled to the one or more computing devices. The computer-executable instructions executed by the processors generate an interactive experience which conveys the information related to the at least one concept or technique employable by the visitor to evaluate works. The interactive experience solicits input from the visitor to provide experiential instruction on the at least one concept or technique employable to evaluate works.

In one example, the interactive experience comprises a color mixer interactive configured to enable the visitor to virtually paint on a virtual canvas provided on the one or more multi-touch displays. The color mixer interactive conveys information related to mixing pigments to create new colors, different paint application techniques, or effects of application of varying composites and proportions of colors. According to another example, the interactive experience comprises a line and shape interactive configured to enable the visitor to combine and manipulate a variety of types of lines, pre-defined shapes, or free-hand creations to convey information related to lines and a relationship between lines and shapes. In yet another example, the interactive experience comprises a sorting and matching interactive configured to display a subset of works from the first set of works to the visitor and to enable the visitor to sort the group of works according to similarity. The sorting and matching interactive conveys information related to evaluation of similarities in works in order to collect, connect, or curate the works.

In another aspect, the education subsystem can further include an interactive display positioned adjacent to a work, of the first set of works, in the exhibition environment. The interactive display conveys interactive information related to the at least one concept or technique as applied to the work.

Still further yet, the exploration subsystem can include an interactive hub apparatus configured to select the second set of works based on the at least one concept or technique. The interactive hub apparatus is further configured to provide an interactive experience to engage the visitor to apply the at least one concept or technique to interpret works of the second set of works.

According to further examples, the exhibition environment includes a plurality of concept spaces into which respective works of the first set of works are grouped, concept spaces of the plurality of concept spaces are respectively associated with disparate concepts or techniques employable to interpret works. According to this example, the education subsystem comprises a plurality of interactive installations respectively associated with the plurality of concept spaces to convey information related to respective concepts or techniques and the exploration subsystem comprises a plurality of hub interactive apparatuses respectively associated with the plurality of concept spaces to link respective concepts or techniques with the second set of works.

In yet another example, the exploration subsystem includes a collection wall apparatus. The collection wall apparatus includes one or more computing devices having respective processors configured to execute computer-executable instructions and one or more multi-touch displays operatively coupled to the one or more computing devices. The computer-executable instructions cause the collection wall apparatus to display the digital representations of the plurality of works, to display thematic subsets of the plurality of works, to enable the visitor to explore specific works of the plurality of works.

In further aspects, the system can include a portable visitor device configured to monitor the visitor in the exhibition environment and record works and concepts explored by the visitor to generate an experience profile associated with the visitor. The portable visitor device is further configured to output interactive media to the visitor as the visitor explores the exhibition environment. The portable visitor device is further configured to determine a location of the visitor within the exhibition environment such that the interactive media output is based on the location of the visitor.

According to another embodiment, described herein is a method for interactively engaging a visitor with a plurality of works in an exhibition environment. The method can include receiving a first user input from the visitor; processing a first digital representation of a first work, of the plurality of works, in response to the first user input, wherein the first digital representation is stored by a content management system that retains digital representations of the plurality of works in the exhibition environment; and displaying the first digital representation of the first work, as processed, on a display. According to an example, the method can further include displaying, on the display, a plurality of digital representations corresponding to the plurality of works including first the digital representation of the first work. Further to this example, the display is a touch display and the first user input is a touch input on an area of the touch display at which the first digital representation is displayed and processing the first digital representation of the first work in response to the first user input comprises enlarging a display size of the first digital representation.

In other examples, processing comprises retrieving, from the content management system, annotative metadata associated with the first work in response to the first user input. The annotative metadata includes at least a set of characteristics corresponding to the first work and displaying the first digital representation comprises displaying an indication of at least one characteristic, of the set of characteristics, in association with the first digital representation.

The method can further include receiving a second user input from the visitor, wherein the second input relates to a selection of a characteristic of the first work from the set of characteristics; and displaying an indication of the characteristic selected on the display. In addition, the method can further include receiving a second user input from the visitor; retrieving, from the content management system, a second digital representation of a second work, the second work being related to the first work by the at least one characteristic; and displaying the second digital representation of the second work on the display in place of the first digital representation of the first work. The display is a touch display and the second user input is a swipe laterally across the first digital representation of the first work displayed on the touch display.

In another example, the method can include receiving a second user input from the visitor, wherein the second user input is an indication of interest in the first work. Further to this example, the method can include updating a count associated with the work in response to the second user input, and/or transmitting information corresponding to the second user input to a portable device of the visitor. The method also includes generating a tour of one or more works in the exhibition environment, guided by the portable device of the visitor, based on the information transmitted, wherein the tour includes at least the first work.

In still yet another example, receiving the first user input comprises capturing a body position of the visitor. According to this example, processing the first digital representation of the first work comprises comparing the body position of the visitor with a body position depicted in the first work and displaying the first digital representation of the first work comprises displaying the first digital representation, an image of the body position of the visitor, and at least one similarity metric. Comparing the facial expression of the visitor with the facial expression depicted in the first work can include comparing the facial expression with a set of facial expression respectively depicted in a set of works and identifying the first work, in the set of works, based on a similarity metric.

According to another example, the display is a touch display. In one example, the first user input is a stroke drawn on the touch display. According to this example, processing the first digital representation of the first work comprises identifying a shape depicted in the first work corresponding to the stroke and displaying the first digital representation of the first work comprises aligning the shape depicted in the first work with the stroke drawn on the touch display. Further to this example, the method can include accessing metadata, retained by the content management system, associated with the plurality of works; comparing the stroke with shape information included in the metadata; and identifying the first work based on a similarity metric. According to another example, the first user input comprises a plurality of drag-and-drop operations, via the touch display, of a set of images on the display. Further to this example, processing the first digital representation of the first work comprises partitioning an entirety of the first digital representation into the set of images and moving the set of images on the display in accordance with the plurality of drag-and-drop operations. Displaying the first digital representation, as processed, can include displaying the set of images as rearranged by the plurality of drag-and-drop operations.

In yet another example, the first user input is a selection of the first work among a set of works displayed on the display. Accordingly, processing the first digital representation comprises acquiring additional image data depicting an original context of the first work, and displaying the first digital representation, as processed, comprises displaying the image data with the first digital representation overlaid in the original context.

According to another example, the display is a touch display and the first user input comprises one or more of a rotation, a pan, or a zoom such that processing the first digital representation comprises performing the one or more of the rotation, the pan, or the zoom. The first user input can relate to a request for additional information. Accordingly, processing the first digital representation of the first work comprises obtaining the additional information from the content management system corresponding to the first digital representation, and displaying the first digital representation, as processed, comprises displaying the additional information.

In another example, the first user input is a location of the visitor within the exhibition environment such that processing the first digital representation of the first work comprises identifying the first work based on the location of the visitor within the exhibition environment. The first work is identified as being on display in the exhibition environment at the location of the visitor.

In yet another embodiment, a system for exploring and engaging with a plurality of works in an exhibition environment is described herein. The system can include a collection wall apparatus configured to enable a visitor to interactively explore the plurality of works of the exhibition environment; one or more interactive apparatuses configured to interactively engage the visitor with at least one work of the plurality of works, a concept employable to interpret the at least one work, or an artistic technique employed to create the at least one work; and a portable apparatus configured to enable interactive exploration of the plurality of works in the exhibition environment, to output annotative information of the plurality of works as the visitor experiences the plurality of works remotely or on site, and to guide the visitor on a tour of the exhibition environment.

According to an example, the collection wall apparatus is further configured to communicate with the portable apparatus to enable the visitor to transmit works selected via the collection wall apparatus to the portable apparatus. The portable apparatus is further configured to generate a tour based on works selected from the plurality of works. The portable apparatus can also be configured to connect to a social media network to share information related to works selected from the plurality of works and/or the tour.

The system can further include a wayfinding system configured to locate the portable apparatus within the exhibition environment. The portable apparatus is further configured to identify works based on a location of the visitor determined by the wayfinding system. The portable apparatus is further configured to guide the visitor on a tour of one or more works within the exhibition environment. The tour is generated by the visitor through a selection of the one or more works via at least one of the portable apparatus or the collection wall apparatus. Alternatively, the tour is a pre-determined tour created by a professional of the exhibition environment.

According to another example, the portable apparatus can include a camera. Further to this example, the portable apparatus is configure to capture an image of a work of the plurality of works via the camera and to output interpretive content related to the work.

In another example, the collection wall apparatus includes a touch display and one or more computing devices coupled to the touch display, the one or more computing devices configured to output display data to the touch display and to receive touch input from the visitor captured via the touch display. The one or more computing devices control output of the display data to alternate between first display data including digital representations of the plurality of works in the exhibition environment and second display data comprising digital representations of a subset of works, of the plurality of works, associated with a theme. The second display data is determined based on a schedule of themes, respective themes of the schedule comprise respective digital representations associated therewith. The collection wall apparatus is further configured to accept input from the visitor to change an order of the schedule of themes. Moreover, the collection wall apparatus is further configured to accept a touch selection on a digital representation of a work to open an exploration interface of the work, wherein, in the exploration interface, an enlarged digital representation of the work and an interactive list of characteristics associated with the work are displayed to the visitor. The exploration interface is configured to receive input for selecting a characteristic from the list of characteristics and to receive input for scrolling through a set of digital representations of a set of works which are collectively share the characteristic selected. According to further examples, the collection wall apparatus further comprises a plurality of user stations respectively configured to interface with disparate portable apparatuses associated with different visitors.

According to further examples, the system can include a content management system comprising non-transitory, computer-readable media having stored thereon digital representations of the plurality of works, annotative metadata associated with the plurality of works, and interpretative content associated with the plurality of works.

Moreover, the one or more interactive apparatuses respectively comprise at least one touch display and one or more computing devices configured to execute computer-executable instructions for providing an interactive experience to the visitor. Through the interactive experience, the visitor engages with the at least one work of the plurality of works, learns the concept employable to interpret the at least one work, or investigates the artistic technique employed to create the at least one work.

As an overview of some embodiments for an exploration, education, and engagement system (and associated methods) for an exhibition environment has been presented above. As a roadmap for what follows next, a general overview of exemplary, non-limiting embodiments and features of an engagement system for an exhibition environment is described in more detail. Afterwards, an exemplary implementation of an engagement system is described. Finally, an exemplary computing device and computing environment, in which such embodiments and/or feature described above can be implemented, are described. The above noted features and embodiments will be described with reference to the drawings, wherein like reference numerals are used to refer to like elements throughout.

### Engagement System for an Exhibition Environment

As mentioned above, in various embodiments, an engagement system provides a rich, interactive experience to visitors of an exhibition environment. The engagement system facilitates education of visitors on various concepts, topics, techniques, etc., which are employable to engage and explore works within the exhibition environment. The engagement system further facilitates propelling visitors, thus educated, into an entirety of the exhibition environment. Such visitors, empowered with specific knowledge, develop greater engagement with the works of the environment, attach personal meaning to the works, create personalize experiences, and generally promote a greater appreciation of the works of the exhibition environment and the exhibition environment itself (i.e., the goals and purpose of the environment).

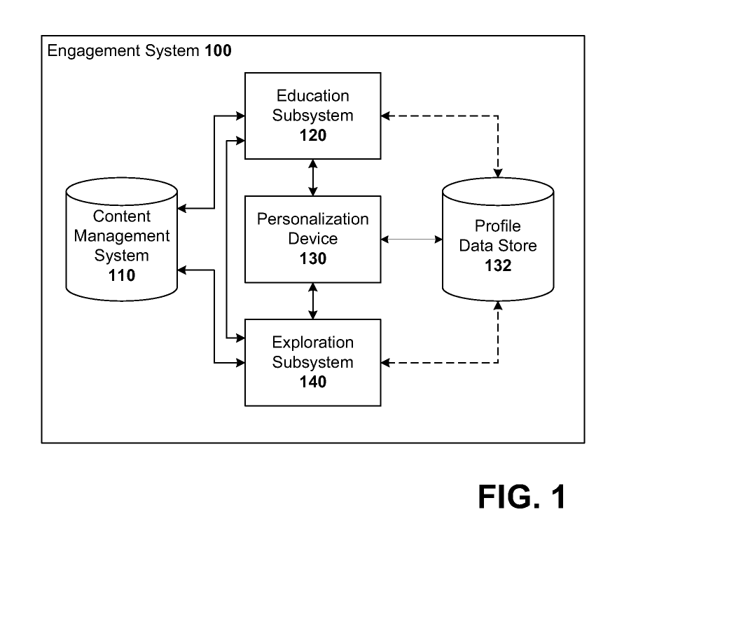

FIG. 1 shows a block diagram illustrating an exemplary, non-limiting embodiment of an education and exploration system configured to facilitate an interactive experience between a visitor of an exhibition environment and a plurality of works of the exhibition environment. Specifically, FIG. 1 illustrates an engagement system 100, which can be employed in an exhibition environment (not shown). System 100 can be utilized in connection with a physical or virtual exhibition environment. For instance, system 100 can be utilized in an art museum or other physical exhibition environment. In addition, system 100 can be leveraged within a virtual exhibition environment such as an online or virtual museum comprising one or more servers retaining digital works or digital representations of physical works, accessible via a client system.

As shown in FIG. 1, the engagement system 100 can include a content management system (CMS) 110 to retain digital representations of a plurality of works including multiple digital representations of individual works, metadata associated with the plurality of works, interpretative information regarding the plurality of works, curated or editorial information, and substantially any other data related to the plurality of works. According to one example, CMS 110 exposes the retained information via an application program interface (API) accessible over a network (i.e., as a web service). However, it is to be appreciated that other access mechanisms can be employed.

Also shown in FIG. 1, the engagement system 100 includes an education subsystem 120 configured to interactively convey information to a visitor. The conveyed information can have an educational focus intended to instruct, entertain, or inform the visitor regarding an interpretative concept or technique, which can be utilized to evaluate works in the exhibition environment. The education subsystem 120 is communicatively coupled (via the exposed API, for example) with CMS 110 in order to generate rich interactive experiences that leverage actual works in the exhibition environment and information regarding those works. As described in greater detail below, the education subsystem 120 generates one or more interactive experiences for visitors of the exhibition environment. The interactive experiences explore various interpretative concepts or technique, utilize media retrieved from CMS 110, and manipulate the media based on user input from the visitors. Generally, these interactive experiences are provided by one or more computing devices executing computer-executable instructions for generating a user interface responsive to user input from visitors in accordance with one or more goals of the interactive experience.

As further shown in FIG. 1, a personalization device 130 is provided. The personalization device 130 enables monitoring visitor interaction with subsystems and modules of the engagement system 100 as well as other objects, areas, or sub-environments of the exhibition environment which exist separate from the engagement system 100. A profile data store 132 can be utilize to retain a visitor profile that records a history of a visitor's interaction within the engagement system 100 and/or the exhibition environment as a whole. The visitor profile can be utilized to provide a personalized experience for the visitor.

According to one example, the personalization device 130 can be an active device such as a portable computing device (e.g., a mobile phone, personal digital assistant, tablet device, smart watch, a piece of jewelry with an embedded computer, or the like). As an active device, the personalization device 130 can be responsible for monitoring the visitor in the exhibition environment. Accordingly, the profile data store 132, in an embodiment, can be incorporated with in the personalization device 130 such the visitor profile is stored on the personalization device 130. However, it is to be appreciated that the profile data store 132 can be managed by the engagement system 100 such that the personalization device 130 transmits information regarding visitor interactions to the engagement system 100 for storage in the visitor profile stored by the profile data store 132.

The personalization device 130 can utilize a communication interface (not shown) to locate the visitor within the exhibition environment. The communication interface can include a wireless technology such as mobile telecommunication protocols, wireless networking (i.e., WiFi), near-field communications, RFID technology, or other low-power RF technology (i.e., Bluetooth) to determine a location of a visitor within the environment. In some embodiments utilizing some technologies, the personalization device 130, via the communication interface, interacts with other devices in the environment to determine the location. For example, the personalization device 130 can interact with devices in the engagement system 100 which are wirelessly enabled, wireless access points within the exhibition environment, Bluetooth-enabled devices, RFID tags and/or readers in the exhibition environment, mobile telecommunication base stations, or the like. Moreover, the communication interface of the personalization device 130 can be utilized to acquire information regarding the interaction of the visitor at the determined location. For instance, as the visitor engages the interactive experiences generated by the education subsystem 120, the personalization device 130 can receive a history or record of the visitor's interaction from the education subsystem 120.

In accordance with another example, the personalization device 130 can be a passive device. In this form, the personalization device 130 includes unique identifier that is readable by devices within the exhibition environment. Accordingly, devices, such as components of the engagement system 100 or other devices dispersed throughout the exhibition environment, can detect the personalization device 130, particularly, the unique identifier associated therewith. These devices can monitor, record, and report information regarding interactions by the visitor (e.g., nature of interaction, duration of interaction, etc.) in associated with the unique identifier such that the visitor profile is constructed.

It is to be appreciated from the foregoing that such visitor profiles can be generated and updated without personal information of the visitor. Instead, the visitor profiles include only information based on a visitor's interaction with the exhibition environment without any link to personal identification information of the visitor. Moreover, the visitor profile can be a one-time profile. For instance, the visitor profile can expire and be expunged from the profile data store 132 on a periodic basis (e.g., daily, weekly, etc). For example, such temporary profiles would exist in situation where the personalization device 130 is issued to a visitor upon arrival to the exhibition environment and returned upon departure therefrom. In this regard, the visitor profile that is constructed to generate a personalized experience for the visitor is usable for one trip only.

As one example where the visitor profile can be utilized, the engagement system 100 further includes an exploration subsystem 140. The exploration subsystem 140 is configured to steer the visitor to explore additional works in the exhibition environment. For example, the exploration subsystem 140 can recommend particular works to the visitor, as well as provide direction for locating the recommended works within the exhibition environment. For instance, based on the visitor profile, the exploration subsystem 140 can generate a tour that is personalized based on the visitor's interaction with other works in the exhibition environment and/or with the interactive experiences provided by the education subsystem 120. According to another example, the exploration subsystem 140 interfaces with the education subsystem 120 to provide guided, empowered exploration of the exhibition environment. For example, based on works utilized to generate interactive experiences to convey interpretive concepts and techniques, related works can be identified by the exploration subsystem 140 to enable the visitor to apply the interpretative concepts and techniques.

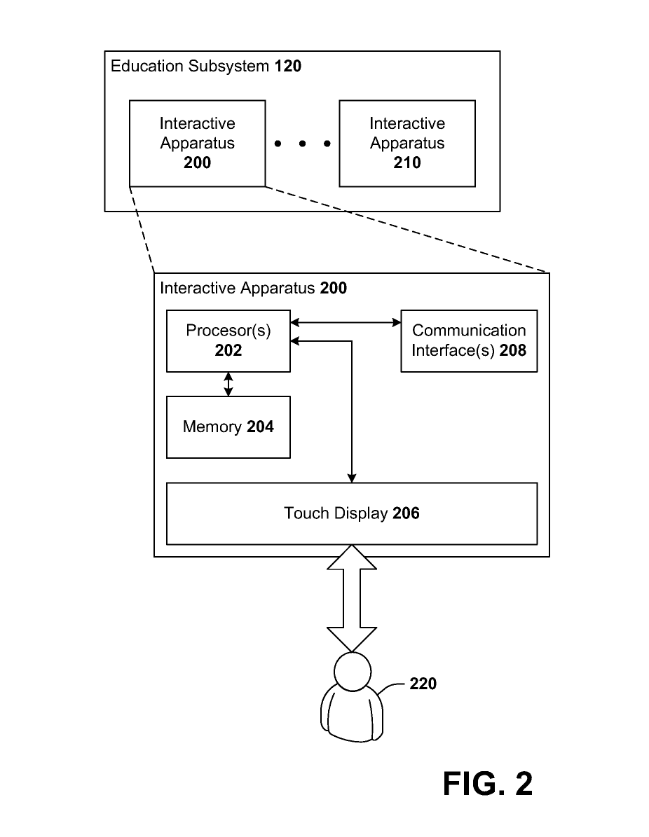

Turning to FIG. 2, illustrated is a schematic diagram of an exemplary, non-limiting education subsystem in accordance with one or more aspects. As depicted, education subsystem 120 can include one or more interactive apparatuses 200, 210. While FIG. 2 shows the education subsystem 120 having two interactive apparatuses, it is to be appreciated that any number of interactive apparatuses, as described herein, can be included in the exhibition environment. As detailed below, the interactive apparatuses 200, 210 can provide a variety of interactive experiences to visitor, which can encompass various scopes within the exhibition environment (i.e., provide an experience at an individual work or exhibit level, a level associated with a collection of works (e.g., a wing or room), or encompass an entirety of the exhibition environment), and installed at substantially any desired location within the exhibition environment.

FIG. 2 illustrates an exemplary, non-limiting structure for interactive apparatus 200. It is to be appreciated that interactive apparatus 210, and any other interactive apparatus of engagement system 100, can have a substantially similar structure. Interactive apparatus 200 can include at least one processor 202 coupled to a memory 204 (e.g., a computer-readable storage medium) and a touch display 206, which can be a multi-touch display. Memory 204 retains computer-executable instructions, which are executed by the processor 202 to generate an interactive experience. The interactive experience is implemented on and provided to a visitor 220 via the touch display 206. Interactive apparatus 200 further includes one or more communication interfaces 208 for transmitting and/or receiving data from other systems and apparatuses included in engagement system 100 or remote therefrom. For instance, the communication interface 208 can be a wired or wireless communication interface configured to communicate with personalization device 130, CMS 110, interactive apparatus 210, devices of exploration subsystem 140, and/or remote systems such as social media outlets, email servers, web servers, or the like.

The interactive experience shapes the encounter visitor 220 has with works in the exhibition environment and promotes empowerment, exploration, creativity, and appreciation of an entirety of a collection controlled by the exhibition environment. In the case of art museum, the interactive experience can promote visual and verbal literacy, highlight basis elements and principles of art, and foster developmental skills such as observation, comparing and contrasting, match, etc. The interactive experience can draw upon or be based on works in the art museum's collection.

The interactive experience can include activities that introduce and expand concepts and techniques employable by visitor 220 to evaluate works. The concepts can include elements of art such as line, shape, form, color, texture, space, value, etc., as well as principles of art such as movement, unity, variety, balance, emphasis, contrast, proportion, pattern, rhythm, or the like. Additional concepts that can be explored via the interactive experience include scale, overlap, perspective, and various other aspects related to color (e.g., hue, intensity, etc.). Certain skills can also be developed with the interactive experience. Such skills include, but are not limited to: comparing, contrasting, and matching; observation and rendering; and/or orientation and navigation.

One exemplary, non-limiting interactive experience can be a color mixer installation. This exemplary interactive experience introduces ideas related to how colors change when mixed together in different proportions. For example, visitor 220, using touch input provided via hands, fingers, or an input device (e.g., paint brush, remote, stylus, etc.), can virtually paint on touch display 206. The interactive experience enables visitor 220 to apply and mix colors to create secondary and tertiary colors. The interactive experience allows the visitor to explore and investigate various application techniques such as fluid brushstrokes, impasto, or splatter painting techniques. Accordingly, the color mixer installation conveys information to visitor 220 regarding how different proportions of colors influence a resultant, final color; results of different mixing or application techniques; and how hue, saturation, and luminance are affected in accordance with varying composites and proportions of colors.

Another exemplary, non-limiting interactive experience can be a line and shape installation. This exemplary interactive experience facilitates an understanding of line and the relationship of line to shape by enabling interactive creative expression using works for the exhibition environment (e.g., artworks of the museum) as a guide. For example, visitor 220, via interaction with the touch display 206, can combine a variety of types of line and/or digitally tear or cut pieces of textured “paper” to create digital murals inspired by digital representations of works in the exhibition environment, which are retrieved from the CMS 110 of engagement system 100. Visitor 220 can also be encouraged to draw free-hand or to create a collage from predefined image elements, including image elements extracted from digital representations of works. Visitor 220 can also explore drawing with different media such as chalk, pastel, conte crayon, etc. Completed projects can be pushed to a display area of touch display 206 (or another associated display (not shown)), shared via social media networks, printed, or transmitted via email or other protocol to visitor 220 or a computing device associated with visitor 220.

Yet another exemplary, non-limiting interactive experience relates to sorting, matching, and/or collecting works. Through this interactive experience, visitor 220 is invited to collect, connect, and curate works. For example, touch display 206 can show digital representations of a plurality of works and, through touch input, visitor 220 can sort the works by pushing or sweeping the digital representations across the touch display 206. A goal of the interactive experience can be to sort, curate or collect works that match in terms of one or more characteristics (e.g., material, theme, cultural origin, etc.).

The forgoing installations are merely examples of some interactive experiences which can be provided to visitor 220 and not intended to be limiting. The interactive experiences can encompass substantially any form of input and/or output and/or any form of experience (e.g., instructional, gaming, etc.) with regard to the works of the exhibition environment. Indeed, other interactive experiences will be evident from the disclosure to follow.

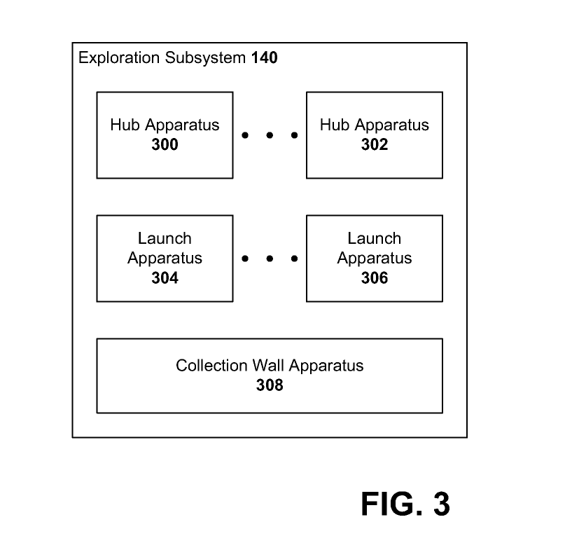

FIG. 3 illustrates a schematic diagram of an exemplary, non-limiting exploration subsystem in accordance with one or more aspects. As shown in FIG. 3, the exploration subsystem 140 can include various apparatuses including one or more hub apparatuses 300, 302; one or more launch apparatuses 304, 306; and a collection wall apparatus 308. While FIG. 3 shows the exploration subsystem 140 having two hub apparatuses, two launch apparatuses, and one collection wall apparatuses, it is to be appreciated that any number of hub apparatuses, launch apparatus, or collection wall apparatuses as described herein, can be included in the exhibition environment. As detailed below, the various apparatuses included in the exploration subsystem 140 are configured to guide the visitor to explore works of the exhibition environment based on input from the visitor and/or information conveyed via the interactive experiences provided by the education subsystem 120. For example, the exploration subsystem 140 can identify additional works of the exhibition environment in which the visitor can apply a specific interpretative concept learned via an interactive experience of the education subsystem 120.

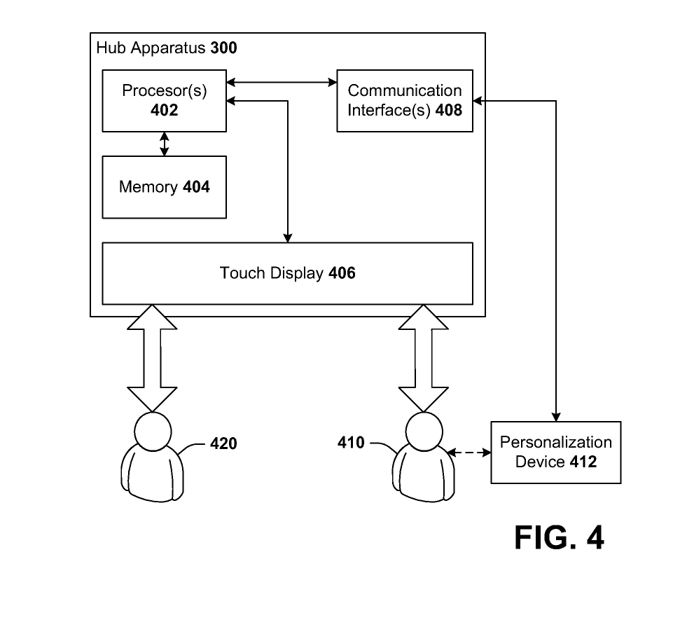

Turning to FIG. 4, illustrated is a block diagram of an exemplary, non-limiting hub apparatus 300. It is to be appreciated that hub apparatus 302 (and any other hub apparatus of engagement system 100) can have a substantially similar structure as that depicted in FIG. 4 for hub apparatus 300. Hub apparatus 300 can include at least one processor 402 coupled to a memory 404 (e.g., a computer-readable storage medium) and a touch display 406, which can be a multi-touch display. Memory 404 retains computer-executable instructions, which are executed by the processor 402 to generate an interactive user interface. The interactive user interface is provided to visitors 410 and 420 via the touch display 406. Accordingly, the hub apparatus 300 can be a multi-user device enabling multiple visitors 410, 420 to simultaneously interact therewith. Hub apparatus 300 further includes one or more communication interfaces 408 for transmitting and/or receiving data from other systems and apparatuses included in engagement system 100 or remote therefrom. For instance, the communication interface 408 can be a wired or wireless communication interface configured to communicate with a personalization device 412 associated with visitor 410, CMS 110, interactive apparatuses of education subsystem 120, launch apparatuses 304, 306, collection wall apparatus 308, and/or remote systems such as social media outlets, email servers, web servers, or the like.

According to an aspect, the hub apparatus 300 interacts with visitors 410 and 420 via the touch display 406 to introduce or recommend works in the exhibition environment in order to guide exploration of the exhibition environment. More particularly, the hub apparatus 300 is configured to provide an interactive experience, which can be similar to the interactive experiences provided by the education subsystem 120. Generally, however, the hub apparatus 300 provides an interactive experience with a greater focus on an entirety of the collection of the exhibition environment. For example, the interactive experiences of the education subsystem 120 seek to introduce and teach a concept or technique to the visitor and typically leverage one or more digital representations of a work. With the hub apparatus 300, the interactive experience provided seeks to engage the visitor in exploring or applying the concept or technique to a plurality of works.

While for the purposes of organization of description the hub apparatus 300 is classified as part of the exploration subsystem 140, it is to be appreciated that the hub apparatus 300 can also provide functionality associated with the education subsystem 120 in that the hub apparatus 300 conveys information related to an interpretative concept or technique. The hub apparatus 300, in an aspect, enables guided application of or deeper instruction on the interpretative concept or technique relative to a larger set of works of the exhibition environment. Further, the hub apparatus 300, through recommendation of similar works, operates to propel the visitor to explore, without the use of interactives, other works of the exhibition environment armed with the newfound knowledge and skills developed at the hub interactive 300, as well as the interactive apparatuses 200, 210 of the education subsystem 120.

In accordance with another aspect, the hub apparatus 300, via communication interface 408, can communicate with the personalization device 412 of visitor 410 to receive a visitor profile corresponding to visitor 410 and/or update the visitor profile of visitor 410 based on interactions conducted with the hub apparatus 300. The hub apparatus 300 can utilize the visitor profile to configure the interactive experience provided to visitor 410. For example, if the visitor profile indicates visitor 410 previously engaged specific interactive experiences of education subsystem 120, the hub apparatus 300 can configure the interactive experience to further explore the corresponding concepts and techniques introduced by those specific interactive experiences. According to another example, the hub apparatus 300 can utilize the visitor profile to identify works that visitor 410 has previously viewed or engaged in order to recommend additional works, selected from an entirety of the works of the exhibition environment, that might interest visitor 410. Moreover, the hub apparatus 300 can record to the visitor profile, via the personalization device 412 for example, a history of works visitor 410 engaged with as part of the provided interactive experience. Such a history can be utilized by other devices of the exploration subsystem 140, as described below, to generate personalized tours of works of the exhibition environment and/or to identify similar or related works likely to be of interest.

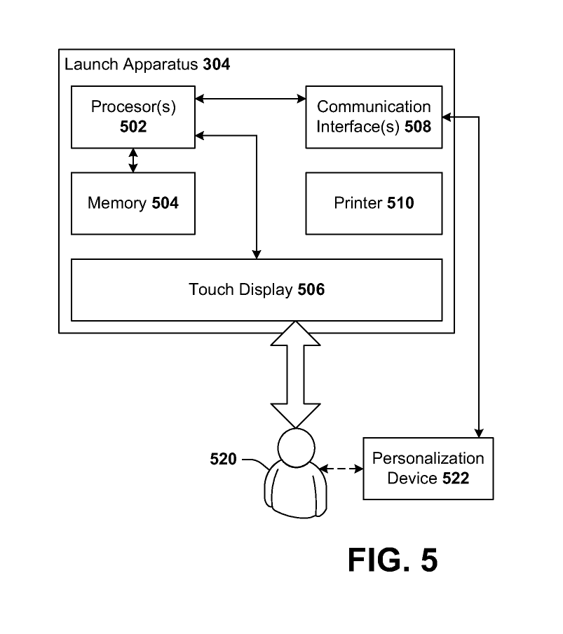

Referring now to FIG. 5, illustrated is a schematic diagram of an exemplary, non-limiting launch apparatus 304. It is to be appreciated that launch apparatus 306 (and any other launch apparatus of engagement system 100) can have a substantially similar structure as that depicted in FIG. 5 for launch apparatus 304. Launch apparatus 304 can include at least one processor 502 coupled to a memory 504 and a touch display 506, which can be a multi-touch display. Memory 504 retains computer-executable instructions, which are executed by the processor 502 to provide an interactive user interface, via touch display 506, employable by visitor 520 to select pre-generated tours or create personalized tours of works of the exhibition environment. The processor 502 further executes computer-executable instructions stored on memory 504 to generate and output such tours. Launch apparatus 304 further includes one or more communication interfaces 508 for transmitting and/or receiving data from other systems and apparatuses included in engagement system 100 or remote therefrom. For instance, the communication interface 508 can be a wired or wireless communication interface configured to communicate with a personalization device 522 associated with visitor 520, CMS 110, interactive apparatuses of education subsystem 120, hub apparatuses of exploration system 140, and/or remote systems such as social media outlets, email servers, web servers, or the like. In addition, the launch apparatus 304 can include a printer 510 for outputting a tour including a map, directions, thumbnail images, interpretative content, descriptions, etc.

According to an aspect, the launch apparatus 304 can display one or more tour templates for selection and/or modification. The tour templates can be pre-generated tours developed by professionals of the exhibition environment. The visitor 520 can select a tour template as provided, or can modify the tour template through addition or removal of works included in the tour template. In building a tour, the launch apparatus 304 can retrieve digital representations of works from CMS 110 for display on touch display 506. A touch input on a digital representation can result in inclusion or removal from a tour being constructed. The tour templates and visitor-generated tours can be retained, in CMS 110 for example. Accordingly, other visitors can retrieve and enjoy tours generated by other visitors.

In accordance with another aspect, the launch apparatus 304, via communication interface 508, can retrieve a visitor profile for visitor 520 from the personalization device 522 or profile data store 132. The visitor profile can be utilized to generate a tour that includes works likely to be of interest to visitor 520. In addition, the tour can be downloaded to the personalization device 522 such that the personalization device 522 can guide visitor 520 on the tour, provide interpretative content, descriptions of work, and/or other interactive media as the visitor 520 proceeds on the tour. In addition to delivery to personalization device 522 or delivery by printing, the tour can be transmitted to a mobile device (e.g., smart phone, cell phone, tablet, etc.) of visitor 522, or another device for later review.

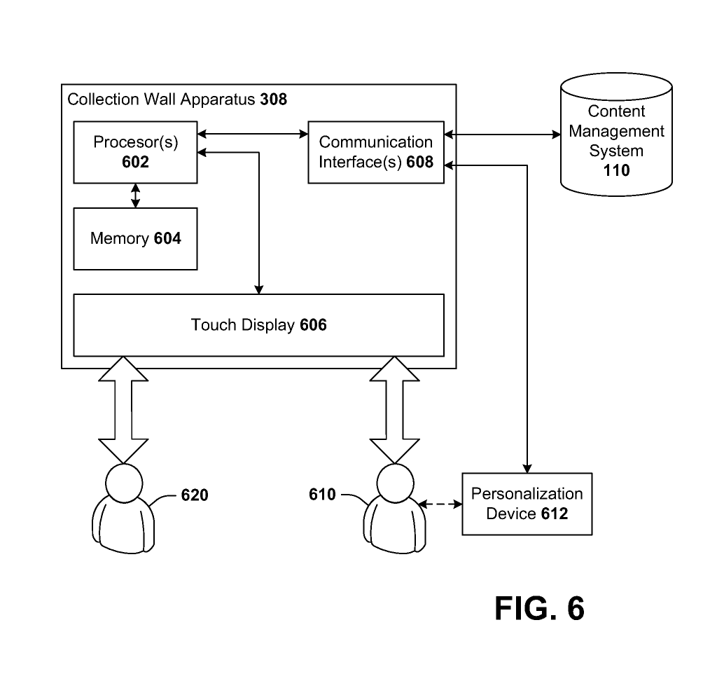

Turning to FIG. 6, a block diagram of an exemplary, non-limiting collection wall apparatus is depicted. Collection wall apparatus 308 can include at least one processor 602 coupled to a memory 604 and a touch display 606, which can be a multi-user, multi-touch display in accordance with one aspect. Memory 604 retains computer-executable instructions, which are executed by the processor 602 to generate an interactive user interface employable by multiple visitors 610, 620 simultaneously. Collection wall apparatus 308 further includes one or more communication interfaces 608 for transmitting and/or receiving data from other systems and apparatuses included in engagement system 100 or remote therefrom. For instance, the communication interface 608 can be a wired or wireless communication interface configured to communicate with a personalization device 612 associated with visitor 610, CMS 110, interactive apparatuses of education subsystem 120, launch apparatuses 304, 306 and hub apparatuses 300, 302 of exploration subsystem 140, profile data store 130, and/or remote systems such as social media outlets, email servers, web servers, or the like.

Collection wall apparatus 308, according to an aspect, is configured to generate an interactive user interface for exploration of an entirety of the works or collection of the exhibition environment. For example, the user interface provided by the collection wall apparatus 308 can display digital representations of the plurality for works of the exhibition environment and can enable visitors 610, 620 to interact with the digital representations, via touch display 606, to retrieve information specific to the corresponding works, to discover related works, to select works to add to a tour, etc. According to one example, the collection wall apparatus 308 can display the digital representations of all works simultaneously to give visitors 610, 620 a visualization of a breadth and scope of the collection offered by the exhibition environment. In another example, the memory 604 can retain computer-executable instructions that configure processor 602 to retrieve digital representations of different thematic sets of works from CMS 110 and to cycle display of the different thematic sets.

The interactive user interface of the collection wall apparatus 308 enables visitors 610, 620 to virtually explore the collection of the exhibition environment. For instance, selecting a digital representation of a work via the touch display 606 can create a virtual workspace on the touch display 606 in front of the visitor 610, 620. This virtual workspace, which is an exploration or working mode of the interactive user interface, can display an enlarged version of the digital representation of the work selected. Descriptive information, keywords (e.g., characteristics, classifications, time periods, etc.), physical location in the exhibition environment, and other information can also be provided on the virtual workspace in associated with the enlarged version of the digital representation of the selected work. In one example, specific keyword(s) can be selected via the touch display 606 and works related to the work selected by at least the specific keyword(s) can be browsed. Moreover, during such virtual browsing, works can be chosen for inclusion on a tour. The generated tour can be downloaded, via communication interface 408 for example, to personalization device 612 to enable visitor 610 to launch the generated tour with the personalization device 612 being a guide. Moreover, the generated tour can be retained, by CMS 110 for example, for selection by other visitors of the exhibition environment.

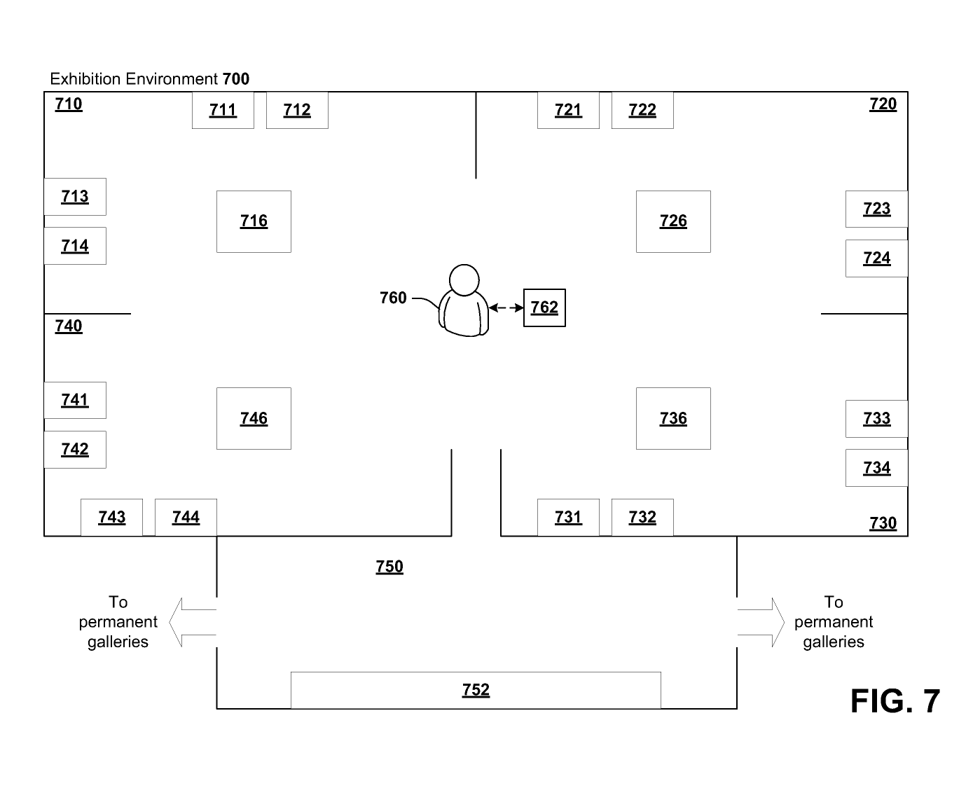

Referring now to FIG. 7, a schematic diagram of an exemplary, non-limiting exhibition environment 700 is illustrated. According to one aspect, the exhibition environment 700 can include spaces 710, 720, 730, 740, 750 in addition to permanent gallery spaces (not shown). These spaces includes concept spaces 710-740 and a launch space 750. Works can be presented in the concept spaces 710-740 in accordance with selected themes or concepts. As shown in FIG. 7, works 711, 713 are displayed in space 710; works 721, 723 are displayed in space 720; works 731, 733 are presented in space 730; and works 741, 743 are displayed in space 740. Interactive apparatuses (712, 714, 722, 724, 732, 734, 742, and 744), referred to in FIG. 7 as rail interactives, are placed in close proximity to the displayed works. These interactive apparatuses can be similar to interactive apparatuses 200, 202 of education subsystem 120 described above. Accordingly, the rail interactive can provide interactive experiences as described above or provide any other experiences described herein.

Hub interactives 716, 726, 736, and 746 are placed in each space 710-740, respectively. Hub interactives 716, 726, 736, and 746 can be similar to hub apparatus 300, 302 of exploration subsystem 140 described above. However, it is to be appreciated that hub interactives 716, 726, 736, and 746 can also include functionality and/or interactive experiences described above as associated with interactive apparatus 200, 202, as well as perform other functions and/or provide other experiences as described below. In launch space 750, a collection wall apparatus 752, which can be similar to collection wall apparatus 308, is placed to facilitate launching visitor 760 into the permanent galleries (not shown) of the exhibition environment.

The spaces 710-750, in an aspect, can be threaded together with a personalization device 762 of visitor 760. However, it is to be appreciated that the spaces, interactives, and apparatuses described herein can function and cooperate without the use of personalization device 762.

What follows is a detailed example describing various aspects of exhibition environment 700, which highlight features of the engagement system 100, education subsystem 120, exploration subsystem 140, personalization device 130, and the various apparatuses included therein. For the sake of descriptive efficiency, spaces 710-740 will collectively be referred to as “spaces”; works 711, 713, 721, 723, 731, 733, 741, and 743 are collectively referred to as “works”; interactive apparatuses 712, 714, 722, 724, 732, 734, 742, and 744 are collectively referred to as “rail interactives”; and hub interactives 716, 726, 736, and 746 are referred to as “hub interactives”.

In accordance with this example, each space corresponds to a different theme and the works displayed each space reflect the corresponding theme. Highly engaging interactives (e.g., the rail interactives) are placed in direct or close proximity to the works installed in the spaces. The interactives, and particularly the content delivered via the interactive experiences, can be modified to reflect changes in the spaces and/or installed works in the spaces. That is, the computer-executable instructions stored on respective memories of the rail interactives can be altered to change the interactive experiences provided and/or to change the content extracted from CMS 110. The rail interactives provide experiences that fascinate visitor 760 in a variety of ways to encourage visitor 760 to continue the encounter with the exhibition environment 700. Through the rail interactives and hub interactives, visitor 760 is engaged to explore the works from different intellectual and conceptual perspectives. The interactives (i.e., the rail interactives and hub interactives) elucidate the concept or theme associated with each space.

According to an example, the spaces can be respectively associated with various concepts of themes, such as: subject and ideas (e.g., related to subject and themes; symbols and ideas; style, subject, and artist, etc.), materials and manufacture (e.g., exploring raw materials, techniques and how raw materials are transformed into finished works, creative process, etc.), authenticity and care (e.g., exploring analysis, authentication, preservation, conservation, etc.), and context and use (e.g., related to an original use/location/audience of the works, the creator in context and culture, an original cultural context of the works, etc.). Each installation or work can introduce a new concept related to the understanding of works generally. Each new concept can be grouped into the theme or broader concept corresponding to the space in which the work is installed.

Exhibition environment 700, organized according to this format, can empower, engage, and teach visitor 760 about the works without encumbrances. The hub interactives inspire visitor 760 to test out the concepts introduced throughout the respective spaces. In addition, the hub interactives connect the works installed within the spaces to other works installed in the permanent galleries to encourage visitor 760 to continue exploring an entirety of the exhibition environment 700.

The concept spaces are designed to celebrate how works of the exhibition environment 700 can be interpreted, appreciated, understood, and viewed as a source of meaning and inspiration to visitor 760. As shown in FIG. 7, each concept space generally follows the same format—namely, works installed in juxtaposition with interactive apparatuses (i.e., the rail interactives) with a hub interactive to bridge the concept space with a remainder of works of the exhibition environment 700.

According to an aspect, the rail interactives output interpretative information about the works installed in proximity Such interpretative information can be conveyed as text, slideshows, images, animations, video, audio, etc. In one example, the rail interactives can output an interactive user interface that incorporates digital representations of the works installed in proximity thereto. Visitor 760 can zoom, pan, and rotate the digital representations of the works. In addition, the digital representations can incorporate “hotspots”, which are portions or features of the digital representations of the works selectable by visitor 760 to cause the rail interactive to present interpretative information related to that portion or feature selected. Thus, as opposed to static, conventional museum labels, the rail interactives provide an experience which fully engages visitor 760.

The rail interactives can further prompt visitor 760 to explore other works in the co-located concept space to guide visitor 760 to a next idea of the overall concept or theme of the concept space. In addition, the rail interactives can prompt visitor 760 to proceed to the hub interactives to fully explore the overall concept of the space, or to other works of the permanent galleries.

The hub interactives provides a bridge between works installed in the concept spaces to related works installed in the permanent galleries of the exhibition environment 700. The hub interactives provide interactive experiences that encourage deeper engagement with the collection, develop understanding through comparison, promote investigative exploration, and, generally, enable visitor 760 to apply the concepts learned throughout the concept spaces. For example, the interactive experiences not only convey deeper information about the works and associated concepts of the concept spaces, but also provide opportunities for visitor 760 to make inferences, draw conclusions, and respond to prompts, which can be visual, aural, and/or textual. In one aspect, the hub interactives can be activated via the personalization device 762 in order to monitor the interactions of visitor 760 with the works and/or concepts of the concepts spaces. The interactions monitored can be incorporated into a visitor profile can be utilized in the launch space, for example, to generate personalized tours of the permanent galleries of the exhibition environment 700.

According to one or more aspects, the hub interactives can provide interactive experiences similar to those provided by the rail interactives. That is, the hub interactives can output an interactive user interface that incorporates digital representations of works within the concepts spaces which visitor 760 can interact with in a manner similar to the interactions described above in connection with the rail interactives. However, it is to be appreciated that the interactive experiences of the hub interactives can be provide a broader or greater connected exploration of the concepts in the concepts spaces. For instance, the interactive experience of the hub interactives can provide interpretative content that bridges or relates to all works in the concepts spaces. For example, a hotspot at the hub interactive can launch interpretive content related to a broad topic applicable to many works as opposed to a specific work.

The launch space 750 operates to orient visitor 760 to an entirety of the works of the exhibition environment 700, as well as bridge the concept spaces to the permanent galleries. Included in the launch space is the collection wall apparatus 752, which can comprise a large multi-user, multi-touch display. In an aspect, the collections wall apparatus 752 can interact with the personalization device 762 to access a visitor profile associated with visitor 760, provide recommendations of other works in the permanent galleries likely to be of interest to visitor 760, generate a custom tour, and download the tour to the personalization device 760 to thereby launch visitor 760 into the permanent galleries. In an aspect, the collection wall apparatus 752 can display digital representations (e.g., thumbnails) of works in the permanent galleries of the exhibition environment. Selection of digital representation can call up a larger, more detailed digital representation, a map indicating a location of the corresponding work, some interpretative content related to the work, etc.

The foregoing description provided a general overview of systems, apparatuses that provide interactive engagement and exploration of works of a exhibition environment. Specifically, exemplary, non-limiting features and aspects were disclosed and it is to be appreciated that the features and aspects disclosed above can be modified, extended, or replaced in accordance with additional aspects and features provided below in an exemplary implementation of the general system in an exhibition environment.

### Exemplary Implementation of an Engagement System for an Exhibition Environment

The following section provides a description of an exemplary, non-limiting implementation of one or more aspects of engagement system 100, described above, in an exhibition environment. Particularly, this section details an installation of an engagement system that incorporates the aspects of the engagement system 100, as well as additional features and aspects, within an art museum. It is to be appreciated that the following example is not intended to limit the general overview of the engagement system 100, but rather illustrates one possible implementation of the features and aspects described above as well as described additional features or aspects that can be accomplished by engagement system 100. That is, the exemplary, non-limiting engagement system and corresponding methods described herein provide elucidation into a full potential of engagement system 100 as generally described previously.

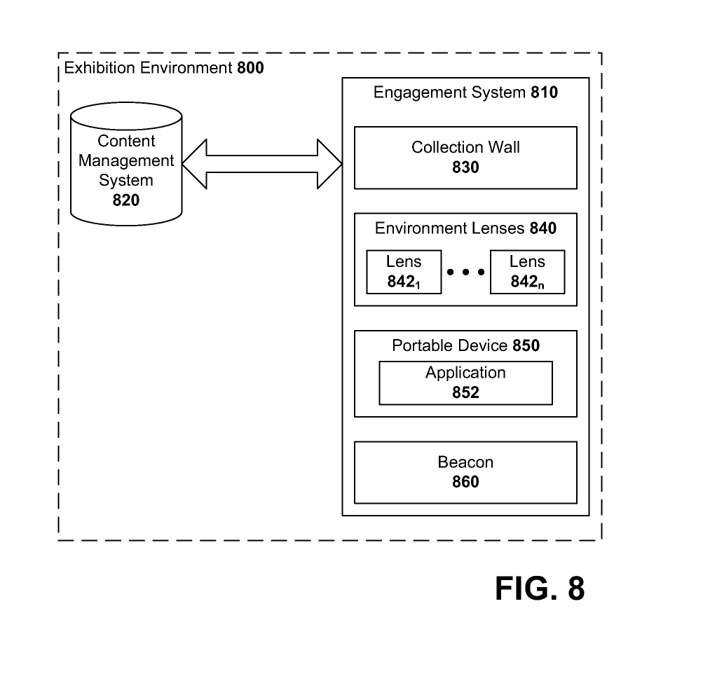

Referring now to FIG. 8, illustrated is a block diagram of an exemplary, non-limiting engagement system implemented in an exhibition environment such as, for example, an art museum. As shown in FIG. 8, an exhibition environment 800 (also referred to herein as art museum 800 or museum 800) can include an engagement system 810 communicatively coupled to a content management system 820. The content management system 820 retains digital representations of a plurality of works (i.e., a collection) of the exhibition environment 800, associated metadata, interpretative content of the plurality of works, visitor-generated information, and/or any other digital assets or information related to the works of the exhibition environment. The content management system 820 exposes an API to enable searching, retrieving, storing, updating, and linking, by the engagement system 810, of the information retained.

The engagement system 810 can include a collection wall 830, environment lenses 840, a portable device 850 having installed thereon an application 852, and a beacon 860. The various components of the engagement system 810 are respectively communicatively coupled with one another as well as content management system 820. As such, the various components of the engagement system 810 can request data from, retrieve data from, and transmit data to one another and the content management system 820.

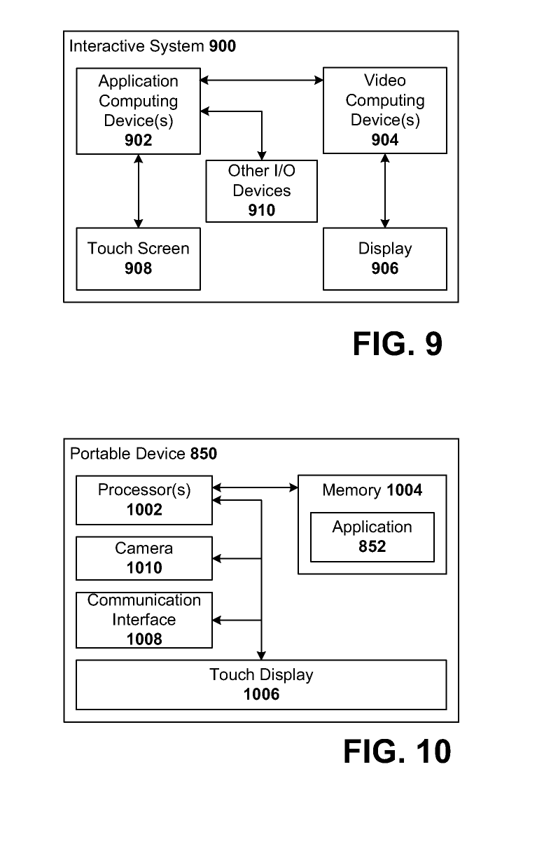

Turning briefly to FIG. 9, a block diagram of an exemplary, non-limiting interactive system 900 is illustrated. In accordance with an aspect, the collection 830, environment lenses 840, and beacon 860 can be implemented by interactive system 900. As shown, interactive system 900 includes one or more application computing device(s) 902 configured to execute one or more applications providing an interactive experience to users (i.e. visitors of the exhibition environment 800). The application computing device(s) 902 receive user input via a touch screen 908 and transmit display output to one or more video computing device(s) 904. The video computing device(s) 904 process the display out from the application computing device(s) 902 for output to a display 906. The interactive system 900 can also include miscellaneous input/output (I/O) devices such as depth sensors, motion sensors, cameras, speakers, microphones, RFID readers, etc. utilized according to one or more aspects described herein. The application computing device(s) 902 and video computing device(s) 904 can include one or more processors, computer-readable storage media, memory, communication interfaces, etc. to enable communications between the components of the interactive system 900, communications with components of engagement system 810, communications with content management system 820, and to execute the functionality described below.

By decoupling touch input from video output, as shown in FIG. 9, the interactive system 900 can fail gracefully. For example, should the interactive application fail such that the interactive system 900 becomes unresponsive to touch input via touch screen 908, the video computing device(s) 904 can continue to output non-interactive video to the display 906 while the application computing device(s) 902 are diagnosed and repaired.

The display 906 can comprise substantially any type of display. For instance, display 906 can be a high-definition video display, a LCD display, an LED display, a rear-projection display, a plasma display, a front projection display, or the like. Moreover, display 906 can include a plurality of display tiles joined together. In one aspect, the one or more video computing device(s) 904 can respectively output video to a respective display tile of the plurality of display tiles of display 906. Similarly, touch screen 908 can comprises one or more individual touch screens based on any suitable touch screen technology, e.g., resistive, surface capacitive, surface acoustic wave, to enable touch input supplied by contact or near-contact with the touch screen 908 by substantially any object, including hands and fingers of users.

FIG. 10 illustrates a schematic diagram of an exemplary, non-limiting portable device according to one or more aspects. The portable device 850 can include a processor 1002, a memory 1004 (e.g., a computer-readable storage medium) having stored thereon the application 852, a touch display 1006, a communication interface 1008, and a camera 1010. In one embodiment, portable device 850 can be tablet device. However it is to be appreciate that other devices such as cell phones, smart phones, PDAs, laptop computers, smart watches, or other portable computing devices can be utilized to execute the application 852.

The application 852 provides wayfinding or location services such that, via the application, a visitor can be presented with digital representations of works in a vicinity of the visitor as well as other digital interpretative content (e.g., video, audio, text, images) related to those works. The application 852 further enables a visitor to browse, onsite or remotely, digital representations of works in the exhibition environment 800. While on site, the application 852 provides guide tours, either curated or visitor-generated. Moreover, utilizing the camera 1010, the application 852 enables a visitor to scan a work and interact with a digital representation of the work, via touch display 1006. For instance, the application 852, upon scanning, can provide an interactive experience similar to that provided by the rail interactives described above. In addition, as described in greater detail below, the application 852, via communication interface 1008, can interact with other devices and/or systems of engagement system 810 as the visitor explores the exhibition environment 800.

For example, the application 852 can be associated with a RFID device such that the application 852 reports, to the engagement system 810, an identifier corresponding with the RFID device and an identifier corresponding to the portable device 850 (e.g., a MAC identifier of the communication interface 1008, an IP address assigned to portable device 850, or some other identifier). Accordingly, any interactive device in engagement system 810, configured with an RFID reader, can read the identifier associated with the RFID device and request, from the engagement system 810, the corresponding identifier associated with the portable device 850. With that identifier, the interactive device can communicate with the portable device 850 detected to be nearby or docked via the RFID device. For instance, the identifier of the portable device 850 can be a network identifier such that the interactive device can communicate with the portable device over a network provided in the exhibition environment 800. It is to be appreciated that other mechanisms such as low frequency RF (e.g., Bluetooth) or near-field communications can be utilized instead of the above described RFID-enabled technique. For instance, various devices (e.g., tags, beacons, etc.) can interact with the portable device 850 (and particularly the application 852) via Wifi, Bluetooth, near-field communications, or other low-energy RF technology for the purposes of location-sensing, context-sensing, wayfinding, or the like.

According to one aspect, the application 852 provides a “Near You Now” function. While on-site, the application 852 integrates with a wayfinding system provided within the exhibition environment 800 to determine a location of the visitor. In an embodiment, the wayfinding system can utilize wireless access points to triangulate the position of the portable device 850. However, other locating techniques can be employed. For instance, RFID tags can be placed throughout the exhibition environment 800, which are identified by the portable device 850 as the visitor travels within the exhibition environment 800. Each tag can be associated with a particular area of the exhibition environment 800 and specific tag, which is the most recently identified, can provide the location of the visitor. It is to be appreciated that substantially any locating technology can be employed provided the capability to locate the visitor within the exhibition environment 800. Based on the determined location, the application 852 alerts the visitor to a set of featured works nearby. The featured works have interpretative media (e.g., video, comparative images, text, audio, etc.) stored by the content management system 110 and deliverable to the visitor via the application 852.

In another embodiment, application 852 provides a “Scan” function that utilizes camera 1010 and image recognition technology to generate an augmented reality experience to the visitor. When a work is scanned, an interactive digital representation of the work is displayed on the touch display 1006 along with interpretative content. The digital representation can indicate “hotspots” selectable by the visitor to retrieve context-sensitive content about the work and, particularly, the portion of the work associated with the hotspots.

In yet another embodiment, application 852 provides a touring feature that enables the visitor to select from both museum-curated and visitor-created tours. The tours indicate locations of work on an interactive map and the application 852 determines the location of the portable device 850 to provide guidance along the tour. The application 852 maintains works favored by the visitor. The application 852 provides mechanisms to enable works on the favorites list to be shared via social media and/or be included on a visitor-created tour. Further, the application 852 provides a schedule of events available at the exhibition environment 800.

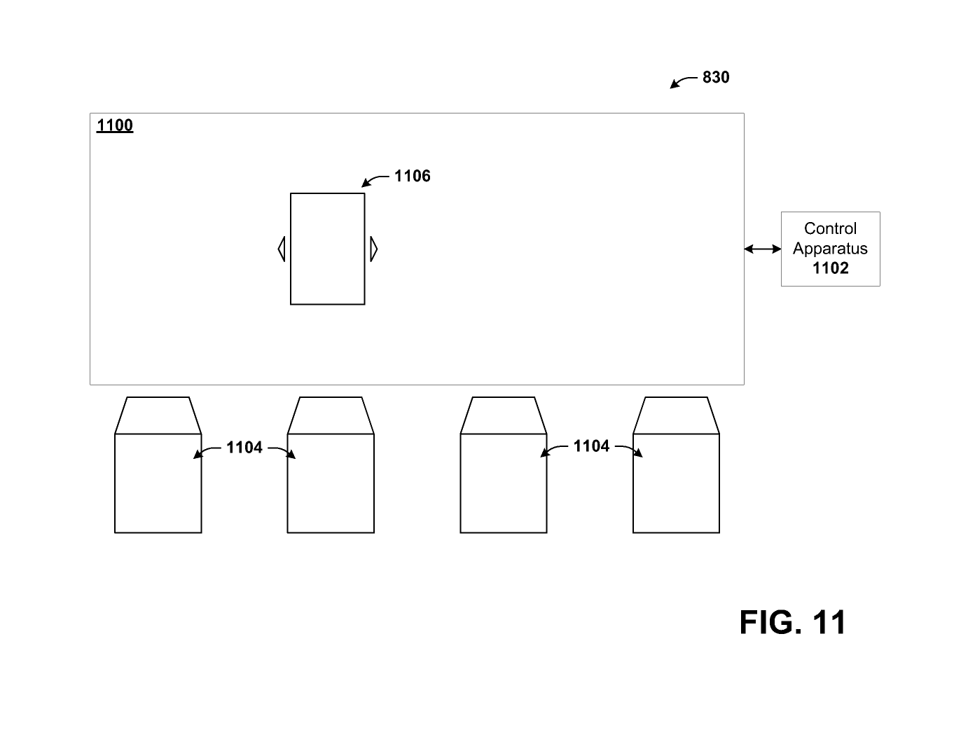

Turning to FIG. 11, illustrated is a non-limiting, exemplary embodiment for a collection wall according to one or more aspects. As depicted in FIG. 11, collection wall 830 can include a touch-enabled display 1100 coupled to a control system 1102. It is to be appreciated that the touch-enabled display 1100 and control system 1102 can be implemented similar to interactive device 900 described above.

According to an aspect, collection wall 830 can display, on touch-enabled display 1100 thousands of digital representations of works available in the exhibition environment 800. For example, the collection wall 830 can display an entirety of a collection of exhibition environment 800. In addition, the collection wall 830 can present, on display 1100, a plurality of different curated themes that respectively include digital representations of a set of works related to the themes. In an embodiment, control apparatus 1102 is configured to loop, in cycles of 30 minutes for example, the display of the curated themes on the display 1100. Each theme can be displayed for a duration (e.g., 40 seconds, 1 minute, etc.). In between the display of themes in a cycle, the control apparatus 1102 can output the display of the full-breadth of the collection. The control apparatus 1102 can output a user interface to display 1100 enabling visitors to alter the loop (e.g., schedule a next theme to be displayed). In addition, the displayed themes and/or the full-breadth display are interactive such that a visitor can touch a digital representation of a work to open an interface that persists on display 1100 for a duration even while the remainder of the display continues to change according to the cycle. The duration can be indefinite provide the visitor maintains interaction with the user interface. The user interface enables the visitor to browse the collection of the exhibition environment 800 by theme, by location, etc., and to indicate specific works as favorites.

The control apparatus 1102 can acquire the digital representations for display from the content management system 810, for example, and regularly poll the content management system 810 for updated information. For instance, as multiple visitors “favorite” works via the application 852 or the collection wall 830, the control apparatus 1102 updates the counts via polling the content management system 810.

A plurality of docking stations 1104 is provided to engage the portable device 850. The docking stations 1104 are configured to physically support the portable device 850. In addition, the docking stations 1104 include sensing devices (e.g., RFID readers) to detect the portable device 850 and enable the control apparatus 1102 to communicatively pair with the portable device 850. Once paired, interactions with the collection wall 830 can be transmitted to the portable device 850. For instance, works favorited on the collection wall can be communicated to the portable device 850 for inclusion on the list of favorites provided by application 852.

In one or more embodiments, the display 1100 can be a physically large display comprising a plurality of tiled display elements. For instance, an exemplary collection wall 830 can include a display 1100 having dimensions of approximately 5′ by 40′ and capable of displaying over 23 million pixels.

Referring back to FIG. 8, environment lenses 840 can include a set of lenses 842₁ to 842ₙ, where n is an integer greater than or equal to 1. Each lens 842 can be implemented similar to interactive device 900 described above and be distributed throughout the exhibition environment 800.

According to one or more aspects, lenses 842 can include respective touch displays (e.g., a 1080p HD display having a 32-point optically-driven multi-touch overlay) and be respectively situated in front of a cluster of thematically, conceptually, or materially related works installed in the exhibition environment 800. Computing devices, such as the application computing devices 902 and video computing devices 904, that power the lenses 842 can be remotely located from the touch displays in order to provide an aesthetically pleasing appearance, a small footprint within the exhibition environment 800, and to reduce cooling requirements and noise. Data provided to lenses 842 can be received these remotely located using, for example, wired connections, wireless connections, or a combination thereof. In embodiments, audio for the lenses 842 can supported from overhead speakers that utilize extremely narrow audio beams to isolate audio to a 2 meter area, for example, anticipated to be a location of visitors during interaction with the lenses 842. Also, as described later, specific lenses 842 of the environment lenses 840 can incorporate additional input devices such as motion capture devices, depth sensors, cameras, etc.

Collectively, the environment lenses 840 provide a variety of interactive multimedia, games and/or vignettes. Each lens 842 can incorporate a similar user interface having a similar home screen design which can frame works situated in front of the respective lenses 842. For example, touching a digital representation of a work on the display can open an interactive providing additional information related to the work. Such additional information related to the work can include high-resolution imagery of the work, including a plurality of angles, which can be dynamic manipulated (e.g., zoomed, rotated, panned, etc.) according to touch input from visitors.

According to additional aspect, each lens 842 can encompass a specific theme or provide one or more unique interactive experiences. For example, a lens 842 can provide a line and shape interactive experience. Through this experience, a visitor can create a stroke by drawing lines across a touch display. The lens 842 matches the stroke to one or more works of the exhibition environment. For instance, the content management system 820 can retain annotated lines respectively associated with a plurality of works of the exhibition environment. The annotated lines are compared with the stroke drawn on the touch display to identify a work having a shape corresponding to the stroke. A digital representation of the work is retrieved from the content management system 820, composites the digital representation with the stroke, and displays the digital representation and the stroke in alignment to enable the connection between the two to become apparent. According to another example, a lens 842 can provide interactive experiences related to how a human form influences works (e.g., sculptures) and how such works are created. For instance, according to a make-a-face interactive experience, the lens 842 captures, via a camera for example, a facial expression of the visitor and matches the facial expression to a work from a set of works of the exhibition environment. In an aspect, the set of works can be imprinted with corresponding facial expressions to enable matching. For example, the imprints can be linked to a database containing data points relating spatial or dimensional similarities between the capture facial expression and the imprint. The lens can output images such as side-by-side displays of the captured facial expression and a digital representation of the matched work. Several side-by-side displays can be collected as photo-booth style. These output images can be shared with other components of the engagement system 810, or shared outside the exhibition environment 800 via email, social media, etc.

In another interactive experience, the visitor is shown an image of a work, such as a sculpture, having a corresponding bodily pose. The visitor is invited to imitate the bodily pose depicted by the work. A motion sensor, depth sensor, or other three-dimensional capture device can detect aspects and/or characteristics the visitor's pose. The lens 842 can determine how closely the visitor's pose compares with the bodily pose of the work. A percentage score can be output, wherein a high percentage indicates a high degree of accuracy. Output images depicting a side-by-side display of the work, the captured pose of the visitor, and/or the score can be displayed by the lens 842 and shared within or outside the environment 800.

In yet another interactive experience, the visitor can construct a clay work using an associated work as a guide. Lens 842 can present the process of creation through an interactive, multi-touch, stop-motion video. Further, lens 842 can provide an interactive experience inviting the visitor to carve away virtual material to reveal the visitor's form as captured by a motion and/or image input sensor. The carving can mimic one or more processes by which real works can be carved.

According to another example, a lens 842 can provide interactive experiences relating to concepts of realism in representation and of art as a visual language. For instance, an interactive experience can utilize polling questions can be asked of a visitor, where the polling questions induce a progression of thought regarding what a particular concept looks like and/or means. Answers from a plurality of visitors can be aggregated into a cumulative infographic output via the lens 842. For example, visitors can be asked what a lion looks like and what a lion means while being shown digital representations of works featuring lions.

In yet another example, a lens 842 can provide interactive experiences related to a theme, such as a time period. One such interactive experience can enable the visitor to draw a line on the touch display. In response, the lens 842 retrieves and displays one or more works, related to the theme (e.g., time period), from the collection of the exhibition environment. The one or more works retrieved incorporate the drawn line. The one or more works are manipulated such that the drawn line is overlaid onto digital representations of the one or more works in a matching fashion. Another interactive experience provided by this lens be an exploration of the theme or time period to provide context. Various multimedia (e.g., a narrative montage including imagery) from the time period can convey a story of events within that time period. The information presented provides context with which to approach works and facilitate a depend understanding of how works fit into general themes of an era.

According to another aspect, a lens 842 can provide interactive experiences relating to a particular medium, such as painting. For example, one interactive experience can present a visitor with a digital representation of a work in the exhibition environment. The visitor is prompted to select one of a plurality of reasons behind why the work was made. Once selected, a visualization can show how other visitors voted. The visualization can appear along with a caption giving further information about the work and the artist associated with the work.

In another interactive experience, the visitor is introduced to a plurality of abstract painting techniques, as represented in one or more works in the exhibition environment 800. The visitor, via the lens 842, can paint on a virtual canvas in the style of an abstract artist, i.e., paint using one or more techniques of the plurality of techniques (e.g., pour, drip, gesture). Available color palettes can be generated from the one or more works of the exhibition environment 800. Visitor generated paintings can be viewable on the lens 842 by other users as well as shared outside the exhibition environment 800 via the Internet.

Another interactive experience can convey concepts such as warped perspective, cubism, and flattening, as often illustrated in the works of Picasso, for example. In this interactive experience, the visitor is able to re-arrange abstracted elements or pieces of a work as desired in order to explore an interplay between flatness and depth. The pieces can be manipulated via multi-touch zoom and rotate gestures. Resultant rearrangements can be displayed and shared like other output imagery from interactive experiences described above.

With an interactive experience related to perspective, one, two and three-point perspectives can be visually presented via animated morphing perspectival overlays as applied to works within the collection. The visitor can manipulate a 3D shape and can shift perspective according to touch points across the horizon lines. With other interactive experiences, one or more artistic processes can be demonstrated. For example, a tempera panel, painting such as Virgin and Child Adored by Saints by Sano di Pietro, can be displayed to the visitor and utilized as an example to demonstrate the tempera process. For instance, the stages of the tempera painting process can be shown at a zoomed in scale. Each step in the process can layer over one another and as one process is completed. The visitor can slide the next step over the last to observe the highly detailed transition and effect of each stage. Each stage can have an accompanying process video as well.

Another lens 842 of environment lenses 840 can provide interactive experience related to globalism and/or the effects of cultural context on market values of works. For example, one interactive experience can utilize images and text to introduce a vase trade of an era. The visitor, through the lens 842, can create a vase by progressively building upon available options (e.g., shape, materials, patterns and techniques), while presented with price estimates of these choices along the way. The final product can be showcased alongside a similar vase within the exhibition environment's collection to illustrate how techniques and origins affect the object's market value. Another interactive can present the visitor with a work and prompt the visitor to guess a country (or countries) that influenced the work to illustrate cultural cross-pollination as depicted in works of the exhibition environment.

Yet another lens 842 of environment lenses 840 can provide interactive experiences related to epic stories or cultural archetypes prevalent throughout history. One such interactive explores how plot points from a story can be identified, presented, and understood from a work of the exhibition environment 800. In an embodiment, plot points the Perseus myth can be extracted from a tapestry installed in the exhibition environment 800. The visitor arranges the plot points to form a story are presented in a variety of styles. For instance, the story can be presented in comic book form where the plot points extracted from the work are arranged by the visitor into comic book cells. Speech bubbles can be added to enable the visitor to include text (e.g., pre-generated or visitor-created). The resultant story created by the visitor can be stored for sharing via the lens 842, other components of engagement system 800, or shared offsite via the Internet.

According to another interactive, the visitor is prompted to match historical and contemporary popular culture examples to a plurality of narrative archetypes. The archetypes can be represented within one or more works immediate to the visitor. Epic stories can be thusly understood as being re-told across different eras and cultures. After a threshold number of matches, the visitor can watch a chronological sequencing of examples within each archetype.

Beacon 860 of engagement system 810 can be implemented similar to interactive device 900 of FIG. 9. However, according to an aspect, beacon 860 generally displays a looping program that includes dynamic and pre-rendered content in a non-interactive manner. The loop of content can cycle continuously, restarting at the completion of each loop. Within a particular loop, the displayed content can incorporate stages of pre-rendered video, staged including composites of pre-rendered and/or generatively drawn content, or stages of dynamic content pulled from other interactives in the exhibition environment 800 such as environment lenses 840. For instance, the photo-booth style strips, capture bodily poses, visitor-generated paintings, stories, vases, etc. can be incorporated into the loop displayed by the beacon 860. In addition, the stage including the composites can be periodically updated to reflect popular works (as determined by a number of favorites, for example). The beacon 860 can include one or more large displays, which can utilized in combination as a single display. In embodiments, the beacon 860 can include a 4×4 array of LED displays (e.g., four 55″ 1080p LED displays) that can deploy a video and communication bus to maintain uniform attributes (e.g., color, refresh rate) across the display.

### Exemplary Networked and Distributed Environments

One of ordinary skill in the art can appreciate that the various embodiments of an engagement system described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the engagement system as described for various embodiments of the subject disclosure.

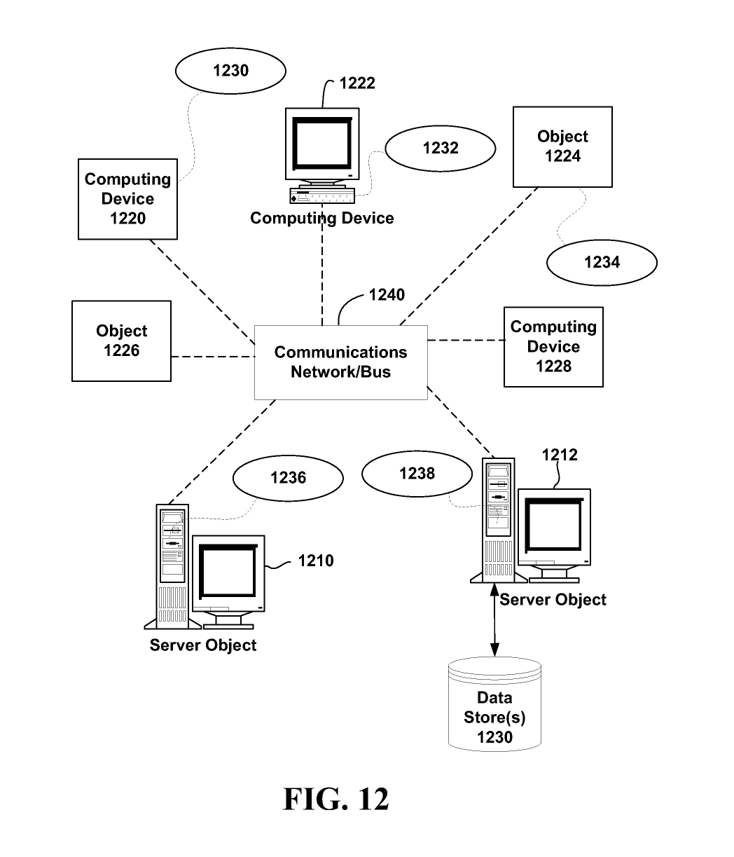

FIG. 12 provides a schematic diagram of an exemplary networked or distributed computing environment. The distributed computing environment comprises computing objects 1210, 1212, etc. and computing objects or devices 1220, 1222, 1224, 1226, 1228, etc., which may include programs, methods, data stores, programmable logic, etc., as represented by applications 1230, 1232, 1234, 1236, 1238. It can be appreciated that computing objects 1210, 1212, etc. and computing objects or devices 1220, 1222, 1224, 1226, 1228, etc. may comprise different devices, such as personal digital assistants (PDAs), audio/video devices, mobile phones, MP3 players, personal computers, laptops, etc.

Each computing object 1210, 1212, etc. and computing objects or devices 1220, 1222, 1224, 1226, 1228, etc. can communicate with one or more other computing objects 1210, 1212, etc. and computing objects or devices 1220, 1222, 1224, 1226, 1228, etc. by way of the communications network 1240, either directly or indirectly. Even though illustrated as a single element in FIG. 12, communications network 1240 may comprise other computing objects and computing devices that provide services to the system of FIG. 12, and/or may represent multiple interconnected networks, which are not shown. Each computing object 1210, 1212, etc. or computing object or device 1220, 1222, 1224, 1226, 1228, etc. can also contain an application, such as applications 1230, 1232, 1234, 1236, 1238, that might make use of an API, or other object, software, firmware and/or hardware, suitable for communication with or implementation of the engagement system and associated mechanisms in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 12, as a non-limiting example, computing objects or devices 1220, 1222, 1224, 1226, 1228, etc. can be thought of as clients and computing objects 1210, 1212, etc. can be thought of as servers where computing objects 1210, 1212, etc., acting as servers provide data services, such as receiving data from client computing objects or devices 1220, 1222, 1224, 1226, 1228, etc., storing of data, processing of data, transmitting data to client computing objects or devices 1220, 1222, 1224, 1226, 1228, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 1240 or bus is the Internet, for example, the computing objects 1210, 1212, etc. can be Web servers with which other computing objects or devices 1220, 1222, 1224, 1226, 1228, etc. communicate via any of a number of known protocols, such as the hypertext transfer protocol (HTTP). Computing objects 1210, 1212, etc. acting as servers may also serve as clients, e.g., computing objects or devices 1220, 1222, 1224, 1226, 1228, etc., as may be characteristic of a distributed computing environment.

### Exemplary Computing Device

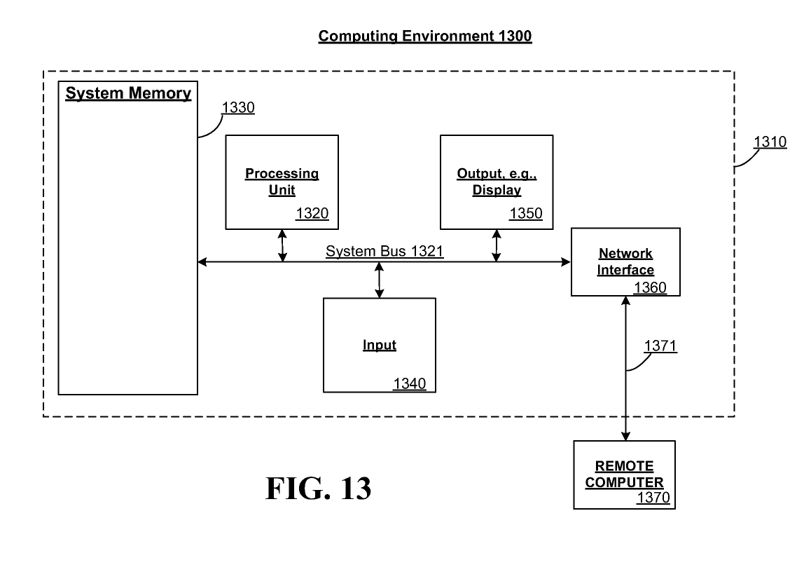

As mentioned, advantageously, the techniques described herein can be applied to any device where it is desirable to provide an interactive experience to educate a visitor on exhibition environment or enable the visitor to explore works of the exhibition environment based on concepts taught interactively. It can be understood, therefore, that handheld, portable and other computing devices and computing objects of all kinds are contemplated for use in connection with the various embodiments of an engagement system. Accordingly, the below general purpose remote computer described below in FIG. 13 is but one example of a computing device.

Embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 13 thus illustrates an example of a suitable computing system environment 1300 in which one or aspects of the embodiments described herein can be implemented, although as made clear above, the computing system environment 1300 is only one example of a suitable computing environment and is not intended to suggest any limitation as to scope of use or functionality. In addition, the computing system environment 1300 is not intended to be interpreted as having any dependency relating to any one or combination of components illustrated in the exemplary computing system environment 1300.

With reference to FIG. 13, an exemplary remote device for implementing one or more embodiments includes a general purpose computing device in the form of a computer 1310. Components of computer 1310 may include, but are not limited to, a processing unit 1320, a system memory 1330, and a system bus 1322 that couples various system components including the system memory to the processing unit 1320.

Computer 1310 typically includes a variety of computer readable media and can be any available media that can be accessed by computer 1310. The system memory 1330 may include computer storage media in the form of volatile and/or nonvolatile memory such as read only memory (ROM) and/or random access memory (RAM). By way of example, and not limitation, system memory 1330 may also include an operating system, application programs, other program modules, and program data. According to a further example, computer 1310 can also include a variety of other media (not shown), which can include, without limitation, RAM, ROM, EEPROM, flash memory or other memory technology, compact disk (CD) ROM, digital versatile disk (DVD) or other optical disk storage, magnetic cassettes, magnetic tape, magnetic disk storage or other magnetic storage devices, or other tangible and/or non-transitory media which can be used to store desired information.

A user can enter commands and information into the computer 1310 through input devices 1340. A monitor or other type of display device is also connected to the system bus 1322 via an interface, such as output interface 1350. In addition to a monitor, computers can also include other peripheral output devices such as speakers and a printer, which may be connected through output interface 1350.

The computer 1310 may operate in a networked or distributed environment using logical connections to one or more other remote computers, such as remote computer 1370. The remote computer 1370 may be a personal computer, a server, a router, a network PC, a peer device or other common network node, or any other remote media consumption or transmission device, and may include any or all of the elements described above relative to the computer 1310. The logical connections depicted in FIG. 13 include a network 1372, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to implement a game for real-world application.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

As utilized herien, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes both computer-readable storage media and communication media including any medium that facilitates transfer of a computer program from one place to another. A computer-readable storage media can be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Also, a connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Illustrative embodiments have been described, hereinabove. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

1. A system for exploring an exhibition environment, comprising:
a content management system comprising non-transitory computer-readable media having stored thereon digital representations of a plurality of works and annotative data respectively associated with the plurality of works;
an education subsystem communicatively coupled with the content management system and configured to convey information related to at least one concept or technique employable by a visitor to evaluate works, the information is conveyed relative to a first set of works of the plurality of works; and
an exploration subsystem, which is communicatively coupled with the content management system and the educational subsystem, and configured to guide the visitor to explore a second set of works of the plurality of works, the second set of works is selected based on at least one of input received from the visitor or characteristics associated with the first set of works to enable the visitor to engage with works of the second set of works in accordance with the at least one concept or technique conveyed by the educational subsystem.

2. The system of claim 1, wherein the education subsystem comprises:
one or more computing devices having respective processors configured to execute computer-executable instructions; and
one or more multi-touch displays operatively coupled to the one or more computing devices,
wherein the computer-executable instructions executed by the processors generate an interactive experience which conveys the information related to the at least one concept or technique employable by the visitor to evaluate works.

3. The system of claim 2, wherein the interactive experience solicits input from the visitor to provide experiential instruction on the at least one concept or technique employable to evaluate works.

4. The system of claim 2, wherein the interactive experience comprises a color mixer interactive configured to enable the visitor to virtually paint on a virtual canvas provided on the one or more multi-touch displays,
wherein the color mixer interactive conveys information related to mixing pigments to create new colors, different paint application techniques, or effects of application of varying composites and proportions of colors.

5. The system of claim 2, wherein the interactive experience comprises a line and shape interactive configured to enable the visitor to combine and manipulate a variety of types of lines, pre-defined shapes, or free-hand creations to convey information related to lines and a relationship between lines and shapes.

6. The system of claim 2, wherein the interactive experience comprises a sorting and matching interactive configured to display a subset of works from the first set of works to the visitor and to enable the visitor to sort the group of works according to similarity,
wherein the sorting and matching interactive conveys information related to evaluation of similarities in works in order to collect, connect, or curate the works.

7. The system of claim 1, wherein the education subsystem comprises an interactive display positioned adjacent to a work, of the first set of works, in the exhibition environment, the interactive display conveys interactive information related to the at least one concept or technique as applied to the work.

8. The system of claim 1, the exploration subsystem further comprising an interactive hub apparatus configured to select the second set of works based on the at least one concept or technique.

9. The system of claim 8, wherein the interactive hub apparatus is further configured to provide an interactive experience to engage the visitor to apply the at least one concept or technique to interpret works of the second set of works.

10. The system of claim 1, wherein the exhibition environment includes a plurality of concept spaces into which respective works of the first set of works are grouped, concept spaces of the plurality of concept spaces are respectively associated with disparate concepts or techniques employable to interpret works,
wherein the education subsystem comprises a plurality of interactive installations respectively associated with the plurality of concept spaces to convey information related to respective concepts or techniques, and
wherein the exploration subsystem comprises a plurality of hub interactive apparatuses respectively associated with the plurality of concept spaces to link respective concepts or techniques with the second set of works.

11. The system of claim 1, wherein the exploration subsystem includes a collection wall apparatus, the collection wall apparatus comprises:
one or more computing devices having respective processors configured to execute computer-executable instructions; and
one or more multi-touch displays operatively coupled to the one or more computing devices,
wherein the computer-executable instructions cause the collection wall apparatus to display the digital representations of the plurality of works, display thematic subsets of the plurality of works, to enable the visitor to explore specific works of the plurality of works.

12. The system of claim 1, further comprising a portable visitor device configured to monitor the visitor in the exhibition environment and record works and concepts explored by the visitor to generate an experience profile associated with the visitor.

13. The system of claim 12, wherein the portable visitor device is further configured to output interactive media to the visitor as the visitor explores the exhibition environment.

14. The system of claim 13, wherein the portable visitor device is further configured to determine a location of the visitor within the exhibition environment such that the interactive media output is based on the location of the visitor.

15. A method for interactively engaging a visitor with a plurality of works in an exhibition environment, comprising:
receiving a first user input from the visitor;
processing a first digital representation of a first work, of the plurality of works, in response to the first user input, wherein the first digital representation is stored by a content management system that retains digital representations of the plurality of works in the exhibition environment; and
displaying the first digital representation of the first work, as processed, on a display.

16. The method of claim 15, the method further comprising:
displaying, on the display, a plurality of digital representations corresponding to the plurality of works including first the digital representation of the first work;
wherein the display is a touch display and the first user input is a touch input on an area of the touch display at which the first digital representation is displayed,
wherein processing the first digital representation of the first work in response to the first user input comprises enlarging a display size of the first digital representation.

17. The method of claim 15, wherein processing comprises retrieving, from the content management system, annotative metadata associated with the first work in response to the first user input.

18-31. (canceled)

32. The method of claim 15, wherein the display is a touch display and the first user input comprises one or more of a rotation, a pan, or a zoom, and
wherein processing the first digital representation comprises performing the one or more of the rotation, the pan, or the zoom.

33. The method of claim 15, wherein the first user input relates to a request for additional information,
wherein processing the first digital representation of the first work comprises obtaining the additional information from the content management system corresponding to the first digital representation, and
wherein displaying the first digital representation, as processed, comprises displaying the additional information.

34-35. (canceled)

36. A system for exploring and engaging with a plurality of works in an exhibition environment, comprising:
a collection wall apparatus configured to enable a visitor to interactively explore the plurality of works of the exhibition environment;
one or more interactive apparatuses configured to interactively engage the visitor with at least one work of the plurality of works, a concept employable to interpret the at least one work, or an artistic technique employed to create the at least one work; and
a portable apparatus configured to enable interactive exploration of the plurality of works in the exhibition environment, to output annotative information of the plurality of works as the visitor experiences the plurality of works remotely or on site, and to guide the visitor on a tour of the exhibition environment.

37. The system of claim 36, wherein the collection wall apparatus is further configured to communicate with the portable apparatus to enable the visitor to transmit works selected via the collection wall apparatus to the portable apparatus.

38-41. (canceled)

42. The system of claim 36, wherein the portable apparatus is further configured to guide the visitor on a tour of one or more works within the exhibition environment.

43. The system of claim 42, wherein the tour is generated by the visitor through a selection of the one or more works via at least one of the portable apparatus or the collection wall apparatus.

44-45. (canceled)

46. The system of claim 36, wherein the collection wall apparatus includes a touch display and one or more computing devices coupled to the touch display, the one or more computing devices configured to output display data to the touch display and to receive touch input from the visitor captured via the touch display.

47-52. (canceled)

53. The system of claim 36, further comprising a content management system comprising non-transitory, computer-readable media having stored thereon digital representations of the plurality of works, annotative metadata associated with the plurality of works, and interpretative content associated with the plurality of works.

54. The system of claim 36, wherein the one or more interactive apparatuses respectively comprise at least one touch display and one or more computing devices configured to execute computer-executable instructions for providing an interactive experience to the visitor,
wherein, through the interactive experience, the visitor engages with the at least one work of the plurality of works, learns the concept employable to interpret the at least one work, or investigates the artistic technique employed to create the at least one work.
